(19) United States
(12) Patent Application Publication
(10) Pub. No.: US 2012/0105815 A1
(43) Pub. Date: May 3, 2012

(54) PROJECTION DEVICE WITH BRIGHTNESS ADJUSTMENT FUNCTION AND METHOD THEREOF

(75) Inventors: YING-CHUAN YU, Tu-Cheng (TW); YING-XIONG HUANG, Tu-Cheng (TW); HSING-CHU WU, Tu-Cheng (TW)

(73) Assignee: HON HAI PRECISION INDUSTRY CO., LTD., Tu-Cheng (TW)

(21) Appl. No.: 12/981,562

(22) Filed: Dec. 30, 2010

(30) Foreign Application Priority Data
Oct. 28, 2010 (TW) 99136841

(51) Int. Cl. G03B 21/28

(52) U.S. Cl. 353/85; 353/121

(57) ABSTRACT

A projection device with a brightness adjustment function includes a reflective display, a light source, a lens module, a power supply unit, a light detection unit and a power controller. The light source emits light to the reflective display. The lens module projects the images displayed by the reflective display. The reflective display is periodically rotated for reflecting the light to the lens module. The power supply unit supplies power for the light source. The light detection unit acquires a digital value of a portion of the light reflected by the reflective display that is not received by the lens module, and compares the digital value with a predetermined digital value to generate a control signal. The power controller adjusts power from the power supply unit to the light source according the control signal until the digital value matches the predetermined digital value of the light.

### BACKGROUND

1. Related Applications

The subject matter disclosed in this application is related to subject matters disclosed in copending applications entitled, “PROJECTION DEVICE WITH BRIGHTNESS ADJUSTMENT FUNCTION AND METHOD THEREOF”, filed **** (Atty. Docket No. US36611); “PROJECTION DEVICE WITH BRIGHTNESS ADJUSTMENT FUNCTION AND METHOD THEREOF”, filed **** (Atty. Docket No. US36615); “PROJECTION DEVICE WITH BRIGHTNESS ADJUSTMENT FUNCTION AND METHOD THEREOF”, filed **** (Atty. Docket No. US36739), and assigned to the same assignee as named herein.

2. Technical Field

The present disclosure relates to projection devices and, particularly, to a projection device having a brightness adjustment function and a method for the same.

3. Description of Related Art

In general, projection devices such as projectors are usually connected to an image output device, such as a video tape recorder or a VCD player. When the projection device projects images onto a projection surface in a room that is not dark enough, the images may look washed out.

### BRIEF DESCRIPTION OF THE DRAWINGS

FIG. 1 is a block diagram of a hardware infrastructure of a projection device with a brightness adjustment function in accordance with an exemplary embodiment.

FIG. 2 is a schematic diagram showing an optical principle of the projection device of FIG. 1.

FIG. 3 is a flowchart of a method having a brightness adjustment function implemented by the projection device of FIG. 1, in accordance with an exemplary embodiment.

### DETAILED DESCRIPTION

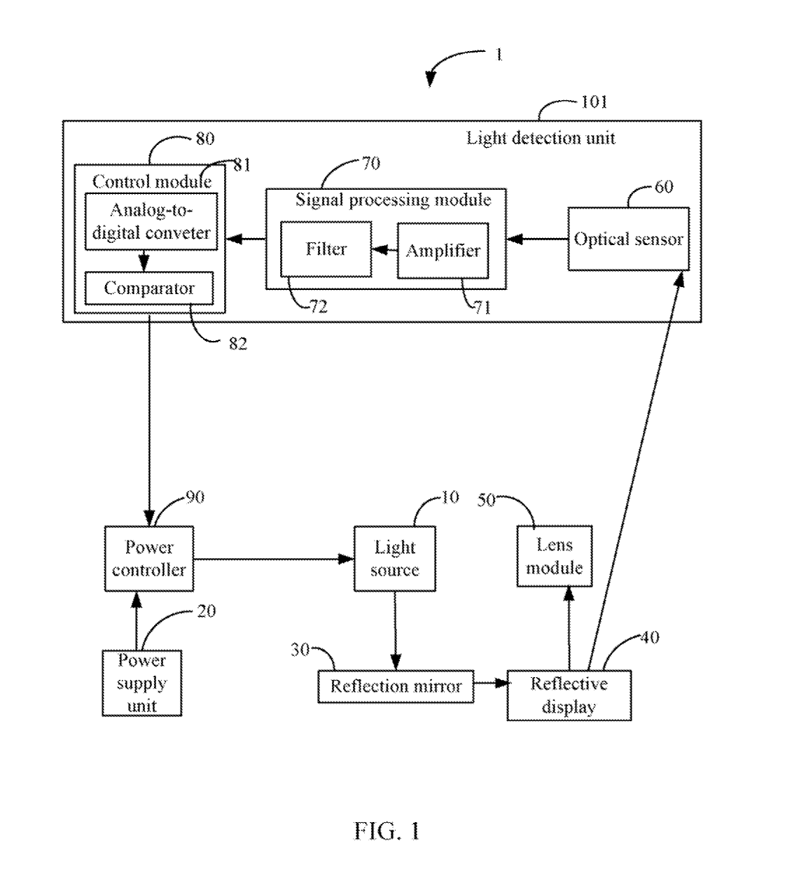

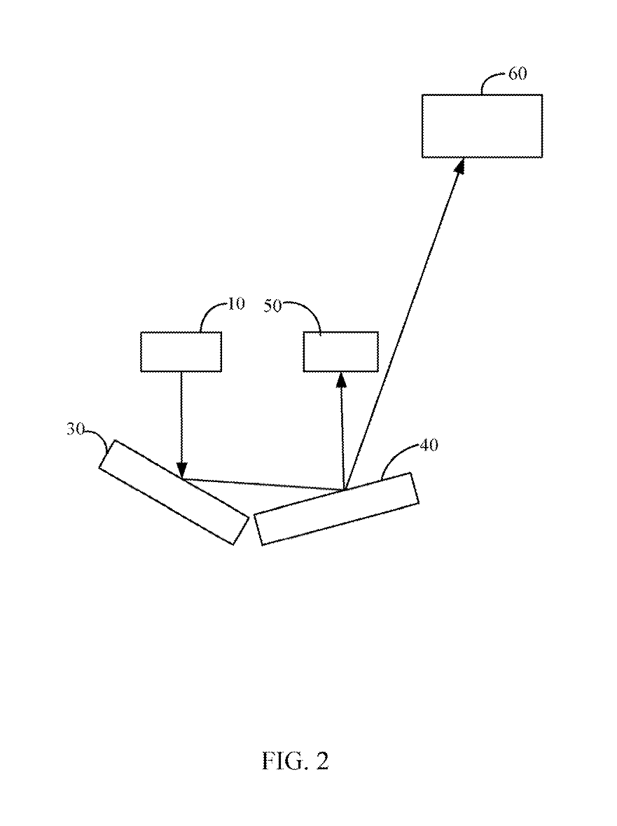

Referring to FIGS. 1-2, a projection device 1 includes a light source 10, a power supply unit 20, a power controller 90, a reflection mirror 30, a reflective display 40, a light detection unit 101 and a lens module 50.

The light source 10 emits light to the reflection mirror 30. In one embodiment, the light source 10 may be an LED, or a RGB LED.

The power supply unit 20 supplies power to the light source 10 through the power controller 90, thereby controlling a digital value of the light from the light source 10.

The reflection mirror 30 reflects the light from the light source 10 to the reflective display 40. The reflective display 40 displays images, and is periodically rotated for reflecting the light to the lens module 50 and the light detection unit 101. The lens module 50 projects the images to be displayed by the reflective display 40 onto a projection surface. In one embodiment, the reflective display 40 is a digital micro mirror device (DMD).

The light detection unit 101 acquires a digital value of the portion of the light reflected by the reflective display 40 that is not received by the lens module 50, and compares the digital value with a predetermined digital value to generate a control signal. In one embodiment, the light detection unit 101 includes an optical sensor 60, a signal processing module 70, and a control module 80. The optical sensor 60 senses the portion of the light reflected by the reflective display 40 that is not received by the lens module 50 to generate a sensing signal. In one embodiment, the optical sensor 60 is a micro-electro mechanical system (MEMS) sensor.

The signal processing module 70 includes an amplifier 71 and a filter 72. The amplifier 71 amplifies the sensing signal from the optical sensor 60. The filter 72 filters the amplified sensing signal to generate an analog signal.

The control module 80 includes an analog-to-digital converter 81 and a comparator 82. The analog-to-digital converter 81 converters the analog signal to a digital signal. The comparator 82 compares the converted digital signal with a predetermined digital signal to generate the control signal.

The power controller 90 adjusts power from the power supply unit 20 to the light source 10 according to the control signal until the digital value matches the predetermined digital value of light from the light source 10. In general, the brightness value of the light, which is emitted by the light source 10 the first time, is optimal. Therefore, the light detection unit 101 acquires the digital value of the portion of the light emitted by the light source 10 the first time as the predetermined digital value.

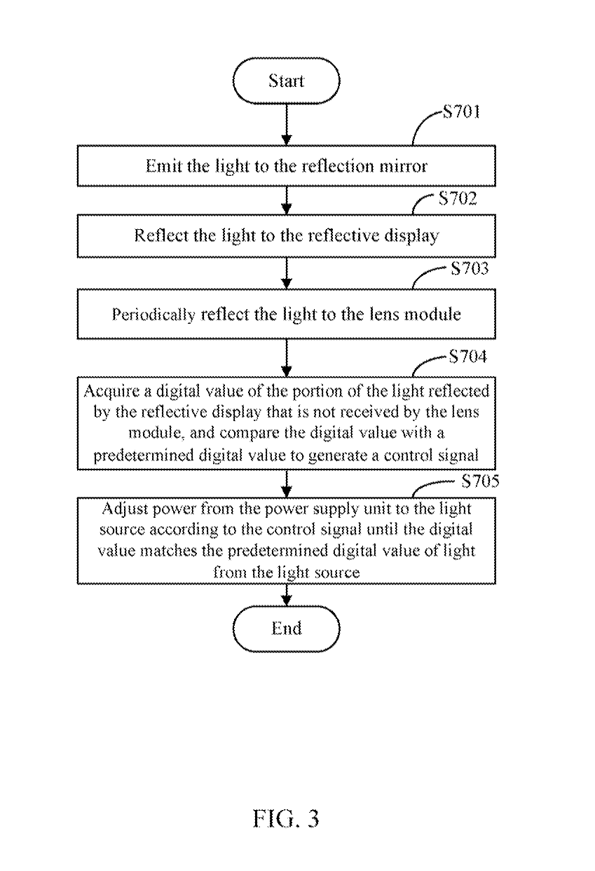

FIG. 3 is a flowchart of a method having a brightness adjustment function implemented by the projection device of FIG. 1, in accordance with an exemplary embodiment.

In step S701, the light source 10 emits the light to the reflection mirror 30.

In step S702, the reflection mirror 30 reflects the light from the light source 10 to the reflective display 40.

In step S703, the reflective display 40 is periodically rotated for reflecting the light to the light detection unit 101 and the lens module 50.

In step S704, the light detection unit 101 acquires a digital value of a portion of the light reflected by the reflective display 40 that is not received by the lens module 50, and compares the digital value with the predetermined digital value to generate the control signal.

In step S705, the power controller 90 adjusts power from the power supply unit 20 to the light source 10 according to the control signal until the digital value matches the predetermined digital value of light from the light source 10.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A projection device with a brightness adjustment function, comprising:
a reflective display;
a light source for emitting light to the reflective display;
a lens module for projecting images to be displayed by the reflective display;
the reflective display being periodically rotated for reflecting the light to the lens module;
a power supply unit for supplying power for the light source;
a light detection unit for acquiring a digital value of a portion of the light reflected by the reflective display that is not received by the lens module, and comparing the digital value with a predetermined digital value to generate a control signal; and
a power controller for adjusting power from the power supply unit to the light source according to the control signal until the digital value matches the predetermined digital value of the light from the light source.

2. The projection device as described in claim 1, further comprising:
a reflection mirror for reflecting the light from the light source to the reflective display.

3. The projection device as described in claim 1, wherein the light source is an LED or a RGB LED.

4. The projection device as described in claim 1, wherein the reflective display is a digital micro mirror device.

5. A method with a brightness adjustment function implemented by a projection device; wherein the projection device comprises a light source, a power supply unit, a lens module and a reflective display, the method comprising:
emitting light to the reflective display;
periodically reflecting the light to the lens module;
acquiring a digital value of a portion of the light reflected by the reflective display that is not received by the lens module, and comparing the digital value with a predetermined digital value to generate a control signal; and
adjusting power from the power supply unit to the light source according the control signal until the digital value matches the predetermined digital value of the light from the light source.
